(19) United States
(12) Patent Application Publication
(10) Pub. No.: US 2015/0356350 A1
(43) Pub. Date: Dec. 10, 2015

(54) unsupervised non-parametric multi-component image segmentation method

(71) Applicant: Mohamad Mustafa Awad, Beirut (LB)

(72) Inventor: Mohamad Mustafa Awad, Beirut (LB)

(21) Appl. No.: 14/296,473

(22) Filed: Jun. 5, 2014

(51) Int. Cl. G06K 9/00; G06T 5/00; G06K 9/52; G06T 7/00

(52) U.S. Cl. CPC G06K 9/00476; G06T 7/0083; G06T 5/00; G06K 9/52

(57) ABSTRACT

A programmed and developed a GUI for an approach which consists of multiple improved techniques or algorithms for an unsupervised and efficient segmentation of multi-component images (multiple spatial and spectral resolutions). Objects existing in the images are detected and separated efficiently which makes the process of object separation easier and more accurate. The process is an unsupervised which requires no intervention from the user and no major parameters are required. The choice of these parameters is affected by the quality of the image which in turn affects the result of segmentation. The new method uses an objective function to maximize heterogeneity (maximize homogeneity inside each object or cluster) between the segmented objects and to reduce the over-segmentation. The new method can provide high speed and acceptable accuracy or normal to slow speed with high accuracy depending on the criticality of the application and the objective of using the final results.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Appendix A

### BACKGROUND OF THE INVENTION

The present invention is in the technical field of image processing whose goals are to improve the extraction of valuable information. More particularly, the present invention is in the technical field of satellite image segmentation which is the process of division of the image into regions with similar attributes [1]. It is an important step in the image analysis chain with applications to pattern recognition, and object detection.

A system which consists of multiple methods for an unsupervised and efficient segmentation of multi-component images (multiple spatial, temporal and spectral resolutions). Objects existing in the images are detected and separated efficiently which makes the process of object separation easier and more accurate. The process is an unsupervised which requires no intervention from the user and no major parameters are required which are affected by the quality of the image which in turn affect the results. The system uses three differ ent objective functions each is for one or multiple methods such that a combination of two of them is to maximize heterogeneity between the segmented objects and the other is to reduce the over-segmentation. The system can provide high speed and acceptable accuracy or normal to slow speed with high accuracy depending on the criticality of the application and the use of the results.

The present invention is discussed in the following with reference to the remote sensing industry, but it is applicable to a variety of contexts and environments, including those that may utilize X-ray, ultrasound, tomography, and many others.

Satellite images have influenced many aspects of modern sciences and applications such as natural resources, natural risks, security and environmental management. The availability of volumetric images from many different types of sensors based on many satellite plat forms requires the creation of a fast, robust, efficient and accurate system of segmentation.

The progress in image segmentation has not reached a point where they can find one system able to process all types of images and to overcome the inherent problems in them such as noise caused by sensor malfunction and atmospheric effects. Most of the existing systems consist of one or more statistical parametric supervised and unsupervised segmentation methods.

Until now, most approaches in this domain use the statistical model for the underlying image but in a parametric form. Some of these methods are supervised with an average efficiency rate of about 85% [2], [3]; how ever, a priori information is needed to get a successful segmentation process, and sometimes, the required information may not be available. Others are unsupervised, employing watershed transforms combined with region merging, watersheds combined with morphological clustering [4], [5], maximum fuzzy entropy with genetic algorithm (GA) [6], discrete wavelet frame with fuzzy-C-mean (FCM) [7]. These parametric approaches are not robust in the sense that their performance is severely affected when the parametric model is not correct. A segmentation method may be correct for one image but may not be correct for another. Satellite images are an important source of information that is used in many environmental assessment and monitoring, agriculture, metrology, mapping, military. Compared to 1972, when the Landsat Multispectral Scanner System (MSS) was launched, satellite image systems now exhibit extraordinary diversity. There are operational satellite systems that sample all available parts of the electromagnetic spectrum with spatial resolution ranging from 0.4 to 1000 m.

### SUMMARY OF THE INVENTION

The present invention is a method which uses both SOM and Hybrid GA (HGA) (simple GA with Hill-climbing process). The new method is able to provide in an unsupervised way the number of clusters without any intervention from us ers. In addition, the new method is not sensitive to noise or to the variability of satellite sensors.

In yet another embodiment of the present invention is reading three types of images jpg, TIF, and BMP.

In yet another embodiment of the present invention is conversion between three types of images from JPG to TIF, from JPG to BMP, from BMP to TIF and vice versa.

In yet another embodiment of the present invention is conversion between 8 bits and 24 bits images.

In yet another embodiment of the present invention, is displaying the histogram of the images the original and the segmented one.

In yet another embodiment of the present invention is building a network of neurons assigning a weight value to each of the neurons utilizing a random based process.

In yet another embodiment of the present invention, the progress of the neuron weights update is shown graphically.

In yet another embodiment of the present invention is the availability of an unsupervised detection of cluster centers or spectral signatures mechanism.

In yet another embodiment of the present invention, is the no or minimum requirements of running parameters.

In yet another embodiment of the present invention, the learning rate for the network is automatic and it is updated until the convergence toward an optimal solution could be local optima.

In yet another embodiment of the present invention is the possibility of the segmentation with Self-Organizing Map (SOM) only.

In yet another embodiment of the present invention is the possibility to segment images with both SOM and Hybrid Genetic Algorithm (SOM-HGA).

In yet another embodiment of the present invention is the possibility to have more than one band (multi-component images) as an input for SOM.

In yet another embodiment of the present invention, the wining neuron is selected usually by using minimum Euclidean distance.

In yet another embodiment of the pre sent invention, all the neurons within a certain neighborhood around the wining neuron participate in the weight update process.

In yet another embodiment of the present invention is that SOM maps patterns from a 3-D (multi-component) color space into a 2-D space.

In yet another embodiment of the present invention is that the number of colors in the space is equal to the number of neurons of the SOM network.

In yet another embodiment of the present invention is that the final weight vectors in the map are used as the new sample space.

In yet another embodiment of the present invention is the existence of a feeding mechanism which provides the output of SOM to HGA for the optimization purpose.

In yet another embodiment of the present invention the system provides a way to remove over-segmentation and under-segmentation using thresholds which are updated continuously using HGA.

In yet another embodiment of the present invention is the presence of a method which creates several individuals “images” which represents population to provide one final optimal image.

In yet another embodiment of the present invention is the presence of re production process to further creates variations in the population.

In yet another embodiment of the present invention is the presence of a method hill-climbing which prevents GA from converging very fast toward a local optima solution.

In yet another embodiment of the present invention is the inclusion of a new objective function which minimizes over-segmentation.

In yet another embodiment of the present invention is the existence of independent feature extraction process such as edge detection to test the outcome before and after the use of the segmentation methods (e.g. noise effects).

In yet another embodiment of the present invention is the possibility to save the final results in any of the following three formats BMP, TIF and JPG.

The system may also preferably includes a computer having software and web navigator able to receive different image formats from different sources and from scanned paper images, wherein the software builds an SOM network for an image, determines an optimal set of cluster centers and further reduces or minimizes redundancy and irrelevant centers. The system can analyze the results and extract important information.

### DETAILED DESCRIPTION OF THE INVENTION

Accuracy obtained using only SOM in image segmentation may often be not satisfactory. So, in order to improve the result of satellite image segmentation, SOM and HGA work sequentially in order to achieve the highest accuracy.

Kohonen's SOM [8] is an unsupervised nonparametric neural network method which converts patterns of arbitrary dimensionality into the responses of 2-D arrays of neurons. One important characteristic of the SOM is that the feature map preserves neighborhood relations of the input pattern. A typical SOM structure is shown in FIG. 1. It consists of an input layer and an output layer. The number of input neurons is equal to the dimensions of the input data. Neurons are, however, arranged in a 2-D array. Each input is fully connected to all units (FIG. 1).

SOM here is used to map patterns from a 3-D (multi-component) color space into a 2-D space. The size of the network depends on the size of the multicomponent image and is empirically determined. The network is composed of a grid of N×N cluster units (neurons), where each is associated with three layers of the multi-component image. At each step in the training phase, the cluster unit with weights that best match the input pattern is elected as the winner usually by using minimum Euclidean distance (described in Module 6 in Appendix A).

$$‖ x - {W}_{l}^{⌊ k ⌋} ‖ = {min}_{i} ‖ x - {W}_{i}^{⌊ k ⌋} ‖ \qquad ( 1 )$$

Where x is the input vector, Wₗ^{[k]} is the weight of the winning unit l at iteration k, and Wᵢ^{[k]} is the weight for neuron i at iteration k. This winning unit and a neighborhood around it are then updated. All the neurons within a certain neighborhood around the leader participate in the weight update process. This learning process can be described by the iterative procedure in (described in Module 7 in Appendix A)

wᵢ^{[k+1]}=wₛ^{[k]}+Hₗᵢ^{[k]}(x−wᵢ^{[k]}) (2)

Where Hₗᵢ^{[k]} is a smoothing Kernel defined over the winning neuron. This Kernel can be written in terms of the Gaussian function

$${H}_{li}^{⌊ k ⌋} = {α}^{⌊ k ⌋} exp ( - \frac{{d}^{2} ( l , i )}{2 {( {σ}^{⌊ k ⌋} )}^{2}} ) \qquad ( 3 )$$

Hₗᵢ^{[k]}→0 when k→T where T is the total number of iterations defined previously to be 1000 iterations. α^{[0]} is the initial learning rate, and it is equal to 0.1. The learning rate is updated with every iteration as

$${α}^{⌊ k ⌋} = {α}^{⌊ 0 ⌋} exp ( - \frac{k}{T} ) \qquad ( 4 )$$

σ^{[k]} is the search distance at iteration k; initially, σ^{[0]} can be half the length of the network or the maximum of either the width or length of the image divided by two. As learning proceeds, the size of the neighborhood should be diminished until it encompasses only a single unit. The decreasing function is described by

$${σ}^{⌊ k ⌋} = {σ}^{⌊ 0 ⌋} ( 1 - \frac{k}{T} ) \qquad ( 5 )$$

After the SOM network converges to balanced state, the original image is mapped from a high color space to a smaller color space. The number of colors in this space is equal to the number of neurons of the SOM network. The final weight vectors in the map are used as the new sample space. In other words, each neuron represents the pixels with their common gray levels (the final weight multiplied by 255) for each band (three bands). This new data set is used for clustering, allowing the determination of a set of cluster centers.

In [9], Holland introduced an optimization procedure. It is a mechanism that mimics the process observed in natural evolution and is known as the Genetic Algorithm (GA). An important characteristic of GA is its ability to find the global optimum solution without being trapped in local minima [10]. In addition, GA is a searching process that is based on the laws of natural selection. and genetics. Usually, a simple GA consists of three operations: 1) selection; 2) genetic operation; and 3) replacement (FIG. 2). Genetic operations are crossing (reproduction) where two parents are selected to mate in order to reproduce new siblings, and mutation is the process of changing one gene (parent) from one type to another. Finally, replacement is the process of replacing two parents with the newly evolved siblings. HGA is a simple GA with the hill-climbing process where the role of this process is to investigate adjacent points in the search space and to increase the fitness of chromosomes (FIG. 2). It is an exploitation technique that is capable of finding local extreme.

The process (FIG. 3) starts by reading a satellite image which can be displayed using the developed software (FIG. 4). Then SOM uses multi-component features of the image to organize the image pixels in groups. Each group value is used as a cluster center and is provided to HGA for selecting the optimal solution in image segmentation (taking into consideration two criteria: 1) the number of pixels in each group and 2) proximity of groups' centers gray values). HGA creates the population of chromosomes (a group of seven genes) where four of the seven genes represent the cluster center provided by SOM and the other three genes represent the gray level value for each pixel in the three bands in the multicomponent image (FIG. 11).

The objective function described in (6) can be used to compute the difference between each pixel and the assigned cluster center.

$$min ( {\sum }_{j = 1}^{k} {\sum }_{i = 1}^{z} [ V ( {P}_{j} ) - {\sum }_{r = 1}^{3} V ( {px}_{ir} ) ] ) \qquad ( 6 )$$

Where k is the number of the cluster centers in a chromosome, and V (Pⱼ) is the value of the three bands of cluster center Pⱼ. It is the sum of the resultant three weights, each multiplied by 255. V (pxᵢ) are the values of the three bands of the pixel on the left side of the cluster center Pⱼ in the chromosome (FIG. 11).

Each iteration, the chromosomes are evaluated using (6), and the best solution is selected. Each chromosome has the image pixel value fixed, but the cluster center value and position are variable. This method will lead HGA to obtain an optimal number of classes (no under or over segmentation). In other words, SOM-HGA will fix the problem of under- and over-segmentation caused by using one method alone.

The developed software consists of many processes and functions such as:
a—Reading an image (Module 1)
b—Displaying an image (FIG. 4) (Module 2)
   1—Sub form showing a displayed image
   2—Another sub form showing another image (a multi-image display application)
c—Displaying the histogram of the image (FIG. 5)
   3—Sub form display histogram
d—Displaying the progress of Self-Organizing Map (FIG. 6)
   4—SOM progress form
e—Reading some information needed in the process such as the number of iterations, values of thresholds if needed to re duce or increase the number of polygons (FIG. 7). There are default values and the dialog gives the choice between using SOM alone or both SOM and HGA.
   5—Initial settings for SOM and HGA form
f—The menus of the new application (FIGS. 8 and 9)
   6—Open and display sub menu
   7—Processes which include SOM-HGA sub menu the topic of this application
g—The hierarchy and relationship between the different modules of the new software is shown in FIG. 10.
h—Different modules are listed in Appendix A.

The efficiency of the new method is proved by applying it to different medium and high resolution satellite images such 1-Landsat-7 Enhanced Thematic Mapper Plus (ETM+) with a resolution 30 meter and size of 129×129 pixels (FIG. 12); Spot 4 XS image with a resolution of 10 meter and size of 193×193 pixels (FIG. 13); and 3-IKONOS image with a resolution of 1 m and a size of 154×154 pixels (FIG. 14).

The results of the segmentation of the three images are shown in FIGS. 15, 16 and 17 respectively. These results were verified by taking a large number of samples and by doing field work using high precision global positioning system as FIG. 17 shows.

The speed and accuracy of the new method depends on the size and complexity of the image and it ranges between 91 to 95%.

### REFERENCES

[1] W. Pratt, Digital Image Processing, 2nd ed. New York: Wiley, 1991.
[2] S. Perkins, J. Theiler, S. Brumby, N. Harvey, R. Porter, J. Szymansk, and J. Bloch, “GENIE: A hybrid genetic algorithm for feature classification in multi-spectral images,” in Proc. SPIE 4120 Appl. and Sci. Neural Netw., Fuzzy Syst. and Evol. Comput. III, 2000, pp. 52-62.
[3] P. Zhang, B. Verma, and K. Kumar, “Neural vs statistical classifier in conjunction with genetic algorithm feature selection in digital mammography,” in Proc. IEEE Congr. Evol. Comput., Canberra, Australia, 2003, pp. 634-639.
[4] Q. Chen, C. Zhou, J. Luo et al., “Fast segmentation of high-resolution satellite images using watershed transform combined with an efficient region merging approach,” Lecture Notes Comput. Sci., vol. 33, no. 22, pp. 621-630, 2004.
[5] P. Pina and T. Barata, “Classification by mathematical morphology,” in Proc. IEEE Int. Geosci. and Remote Sens. Symp., 2003, pp. 3516-3518.
[6] X. Wang and B. Wong, “X-ray image segmentation based on genetic algorithm and maximum fuzzy entropy,” in Proc. IEEE Conf Robot., Autom. and Mechatronics, Singapore, 2004, pp. 991-995.
[7] M. Fauzi and H. Lewis, “A fully unsupervised texture segmentation algorithm,” in Proc. Brit. Mach. Vis. Conf, 2003, pp. 519-528.
[8] T. Kohenen, “Self-organizing maps,” in Information Sciences, vol. 30. Berlin, Germany: Springer-Verlag, 2001.
[9] J. Holland, Adaptation in Natural and Artificial Systems. Ann Arbor, Mich.: Univ. Michigan Press, 1975.
[10] S. C. Ng, S. H. Leung, C. Y. Chung, A. Luk, and W. H. Lau, “The genetic search approach—A new learning algorithm for adaptive IIR filtering,” IEEE Signal Process. Mag., vol. 13, no. 6, pp. 38-46, November 1996.

### BRIEF DESCRIPTION OF THE DRAWINGS

FIG. 1. The Self-Organizing Map ANN network structure

FIG. 2. The Hybrid Genetic Algorithm which combines GA and Hill-Climbing.

FIG. 3. The complete SOM-HGA process in General

FIG. 4. The display of images process in the application

FIG. 5. Shows the histogram of an image displayed by the application

FIG. 6. Shows the progress of the SOM evolution in the application

FIG. 7. Form for entering initial variables for SOM-HGA method

FIG. 8. Menu of opening and displaying images in the application

FIG. 9. Menu of the SOM-HGA process in the application

FIG. 10. A detailed description of the interaction between the modules of SOM-HGA

FIG. 11. Chromosome structure

FIG. 12. Landsat ETM satellite image

FIG. 13. SPOT 4 XS satellite image

FIG. 14. Ikonos satellite image

FIG. 15. Segmented Landsat image

FIG. 16. Segmented SPOT image

FIG. 17. Segmented Ikonos image with sample locations+GPS (black spots)

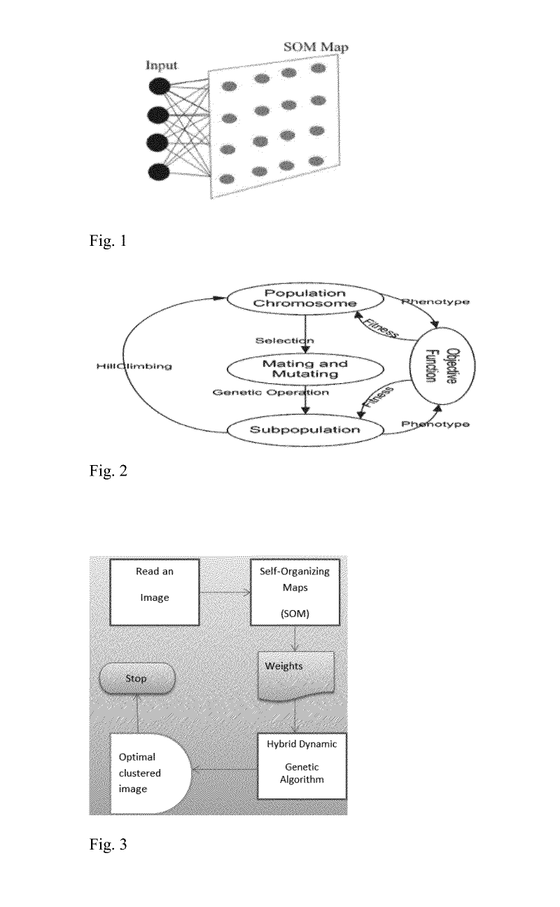

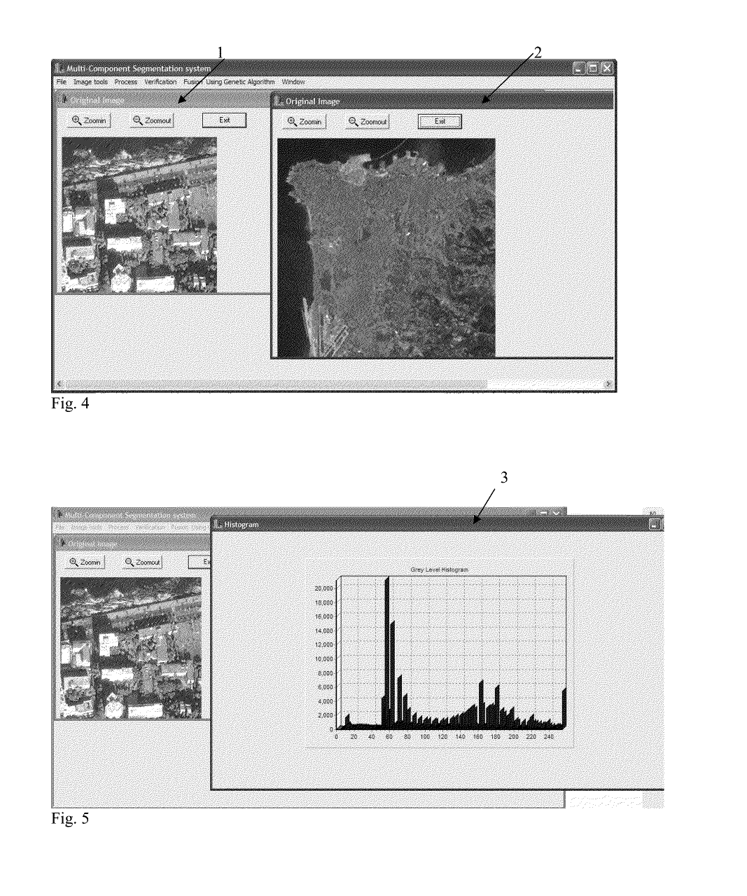

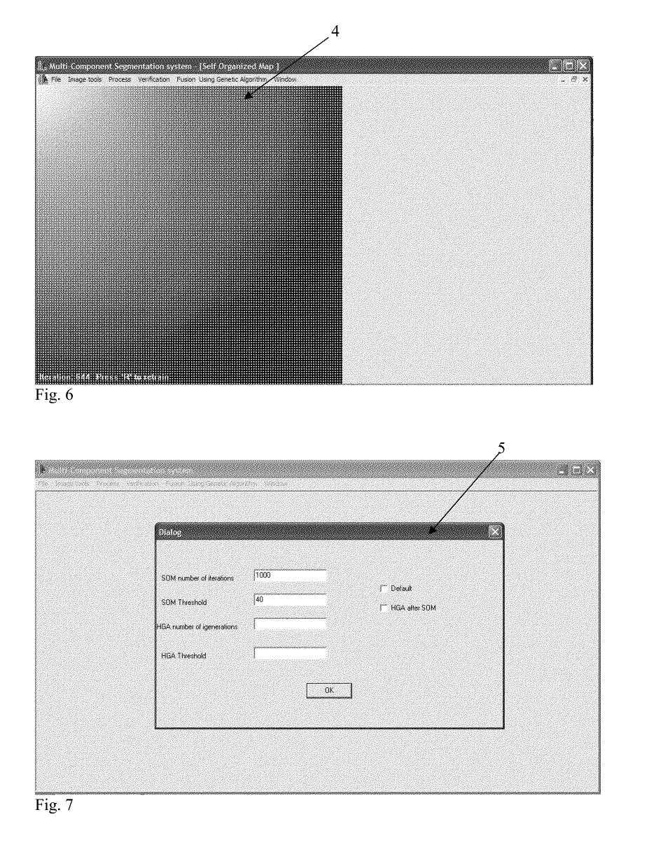

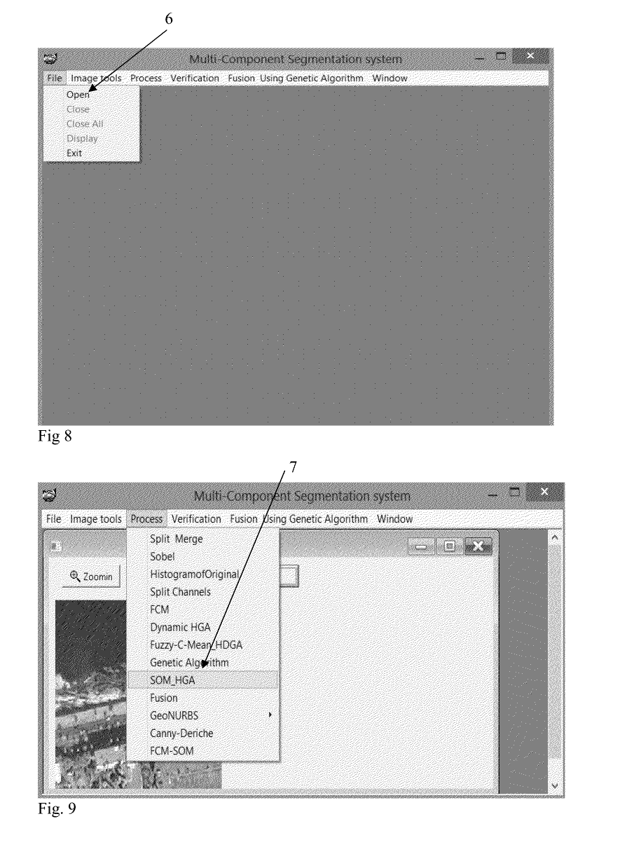

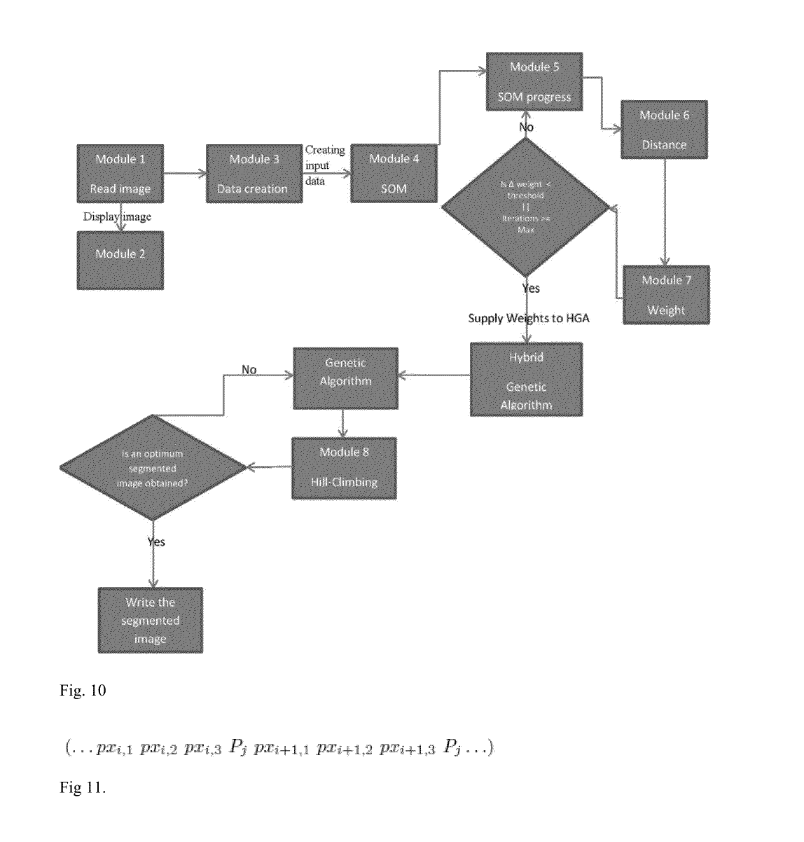

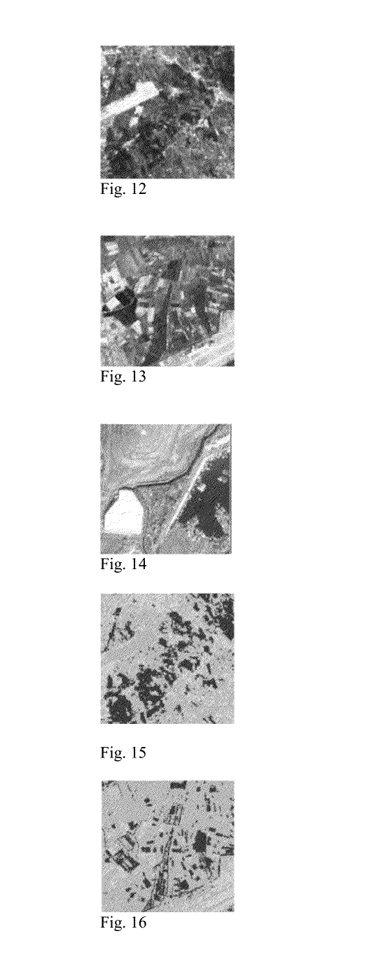

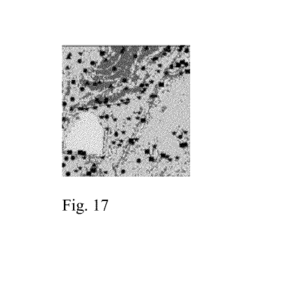

1. A method for multi-component image segmentation comprising:
a. multi-spectral, multi-spatial, multi-temporal image data;
b. Enhancement of the image by filtering noise
c. Enhancement the contrast of the image
d. Edge enhancement in the image;
e. a method to segment the image using Genetic algorithm (GA) only
f. a method to segment the image using Self-Organizing Maps (SOMs) only
g. an approach that combine the previous two methods

2. The method of claim 1 wherein the multi-component image data represents a natural image such as satellite image.

3. The method of claim 1 wherein multi-component image data represents synthetic image such as satellite radar image.

4. The method of claim 1 wherein the multi-component image can be a pan-sharpened image.

5. The method of claim 1 uses Artificial Neural Network (ANN) to reduce the feature space from m dimension to n dimension where n<m

6. The method of claim 1 uses an unsupervised method ANN method based on Self-Organizing Maps with a cost function.

7. The method of claim 1 uses an ANN based on the minimization of the cost function that computes the distance between a selected neuron and the neighboring ones each with a changing weight.

8. The method of claim 1 uses the result of the unsupervised ANN to create the population of the second process in this new method.

9. The method of claim 1 connects ANN results to another evolutionary computation algorithm Genetic Algorithm (GA) to eliminate over segmentation.

10. The method of claim 1 creates the population of GA from the weights provided by the unsupervised ANN process.

11. The method of claim 1 uses GA with several constraints which define the minimum number of pixels per clusters. It is an interactive mode which is either defined by the user or provided automatically.

12. The method of claim 1 uses hybrid Genetic Algorithm (GA) which consists of Hill-Climbing process and other processes including GA.

13. The method of claim 1 can be used without any defined or calculated parameters it is a nonparametric method.

14. The method of claim 1 includes an interface to define the size of the GA population.

15. The method of claim 1 includes metrics to evaluate the progress of the solution.

16. The method of claim 1 can save the result as an image with different formats such as “jpg”, “Tif”, and “BMP”.

17. The method of claim 1 is able to create geo-referenced images which can be used with any Geographic Information System or any Remote Sensing application.
